(19) United States
(12) Patent Application Publication
(10) Pub. No.: US 2023/0352946 A1
(43) Pub. Date: Nov. 2, 2023

(54) ADVANCED BATTERY MANAGEMENT SYSTEM (BMS) FOR CHARGE EQUALIZATION OF SERIALLY CONNECTED ELECTRICAL STORAGE CELLS

(71) Applicant: IRP NEXUS GROUP LTD., Nes Ziona (IL)

(72) Inventors: Paul Price, Nes-Ziona (IL); Shmuel Ben Yaakov, Tel Yitzhak (IL); Stanislav Tishechkin, Rosh HaAyin (IL)

(21) Appl. No.: 18/042,596

(22) PCT Filed: Aug. 24, 2021
(86) PCT No.: PCT/IL2021/051037

§ 371 Date: Feb. 22, 2023

(30) Foreign Application Priority Data
Aug. 25, 2020 (IL) 276933

(51) Int. Cl. H02J 7/00; H01M 10/44

(52) U.S. Cl. CPC H02J 7/0016; H02J 7/007192; H01M 10/441; H01M 10/443

(57) ABSTRACT

Apparatus for controlling the charging level of a bank of serially connected electrical cells and performing equalization of the charges in the battery array, comprising circuitry for alternately connecting a capacitor to pairs of adjacent battery cells by controlling switches at a predetermined switching frequency; circuitry adjusting the switching frequency to control the impedance of the equivalent resistance of transfer, such that the charging/discharging current is maintained within a range of desired values.

### CROSS-REFERENCE TO RELATED APPLICATION(S)

This application is a Section 371 National Stage Application of International Application No. PCT/IL2021/051037, filed on Aug. 24, 2021, entitled “ADVANCED BATTERY MANAGEMENT SYSTEM (BMS) FOR CHARGE EQUALIZATION OF SERIALLY CONNECTED ELECTRICAL STORAGE CELLS”, which claims priority to Israeli Application No. 276933, filed on Aug. 25, 2020, incorporated herein by reference in their entirety.

### TECHNICAL FIELD

The present disclosure relates to the field of Battery Management Systems (BMS). More particularly, the present disclosure relates to a system and method for performing equalization of the state of charge of serially connected electrical cells, such as battery cells or supercapacitors and the like, that form a high voltage assembly.

### BACKGROUND

Nowadays, in many electrical products, including electrical vehicles, there is a need to use an array of electrical cells connected to each other in series (for example, lithium Ion batteries, supercapacitors or solar cells). Since these types of batteries are expensive, they are frequently a major part of the product price. Therefore, maintaining and protecting them is an important and necessary need.

When charging and discharging serially connected electrical cells, a situation in which one battery cell is charged more than the other, may arise. Such a situation may damage these battery cells. The damage is mainly caused when there is a charged battery cell that continues to be charged and then it is being overcharged and severely harmed, leading to expensive costs of replacing the batteries with new ones. Or, when a solar cell in a solar panel has a lower output current and will thus limit the output power of the whole panel. Therefore, there is a need to perform equalization of the charge levels among these cells.

There are several conventional methods to perform equalization of the charge levels among the electrical cells connected in series: active methods and passive methods. In the passive methods, when the state of charge of a battery cell reaches a maximum, the extra charge is dissipated by a parallelly connected resistance. This is accomplished by measuring the voltage of each battery cell and activating a switch (such as a transistor) to connect a resistor in parallel to the cell that needs to be discharged. This passive method causes great loss of energy (loss of power) and therefore, is inefficient. The active (dynamic) methods try to avoid the energy loss by transferring the excess stored energy from a highly charged cell to other cells, which are less charged.

One way to accomplish this is by using the so-called “flying-capacitors”, which connect to one cell and then to the next cell in the battery, using transistors which work in tandem. This method is presently more expensive than the passive equalization method due to the need to drive transistors, which are not referred to the control-circuit ground. This calls for multiple isolated gate drivers which are expensive. Another disadvantage of the conventional active equalization method is that the rate of charge transfer is not controllable, which may prolong the equalization time. Yet another shortcoming of the conventional active battery equalization method is that there is a need for cell voltage monitoring to determine when to stop the equalization process and hence, save the unnecessary operational power drain.

It is therefore an object of the present disclosure to provide a system and method for performing equalization of the state of charge of an array of cells connected in series, in a manner that saves energy (power).

It is another object of the present disclosure to provide a system and method for performing equalization of the charges of the electrical cells connected in series, in a cost-effective manner.

It is yet another object of the present disclosure to provide a system and method for performing equalization of the charges of the batteries in an array of electrical cells connected in series, in a manner that controls the rate of charge transfer.

Other objects and advantages of the disclosure will become apparent as the description proceeds.

### SUMMARY

A method for controlling the charging level of a bank of serially connected electrical cells and performing equalization of the charges in the battery array, comprising the steps of:
a) alternately connecting a capacitor to pairs of adjacent battery cells by controlling switches at a predetermined switching frequency; and
b) adjusting the switching frequency to control the impedance of the equivalent resistance of transfer (Rₑ), such that the charging/discharging current is maintained within a range of desired values.

Equalization may begin when the voltage difference between any two cells is larger than a predefined value and ends when the voltage difference is smaller than a predefined value.

The switching frequency may change according to a predefined profile of the switching frequency, versus time.

The method may further comprise the steps of:
a) determining when to start changing the switching frequency by measuring the temperature of a common heatsink/heatsinks, which dissipate the power losses during equalization of all battery cells, such that the temperature of the heatsink will not increase above a predetermined value; and
b) reducing the equivalent resistance of transfer by increasing the switching frequency, when the heat sink temperature is below a predetermined level, thereby expediting the equalization process.

Drive signals may be provided to all switches, without using isolated drivers by providing switching signals to each switch via a series DC decoupling capacitor, such that when a pulse is fed into a series capacitor, the positive pulse portion passes to the gate of each switch to pass energy from the equalizing capacitor to a battery cell while allowing each series capacitor to charge back to the former voltage, to be ready for the next cycle.

A method for controlling the charging level of a bank of serially connected n electrical cells (B₁ . . . Bₙ) performing equalization of the charges in the battery array, comprising the steps of:
a) alternately connecting a capacitor to pairs of adjacent battery cells by controlling switches at a predetermined switching frequency;
b) alternately connecting an extra external capacitor to cells B₁ . . . Bₙ₋₁ and to cells B₂ . . . Bₙ;
c) measuring the current of the extra capacitor;
d) adjusting the switching frequency to control the impedance of the equivalent resistance of transfer (Rₑ), such that the charging/discharging current is maintained within a range of desired values.

The current of the external common capacitor may be passed through a sense resistor, the voltage drop across which is fed into a controller, capable of changing the switching frequency of an equalizer.

The sense resistor may be connected between ground and a transistor that toggles the external capacitor.

The controller's decision to start or stop the equalization process may be based on the current magnitude of the external capacitor.

Apparatus for controlling the charging level of a bank of serially connected electrical cells and performing equalization of the charges in the battery array, comprising:
a) circuitry for alternately connecting a capacitor to pairs of adjacent battery cells by controlling switches at a predetermined switching frequency; and
b) circuitry adjusting the switching frequency to control the impedance of the equivalent resistance of transfer (Rₑ), such that the charging/discharging current is maintained within a range of desired values.

The control circuitry may be adapted to:
a) determine when to start changing the switching frequency by measuring the temperature of a common heatsink/heatsinks, which dissipate the power losses during equalization of all battery cells, such that the temperature of the heatsink will not increase above a predetermined value; and
b) reduce the equivalent resistance of transfer by increasing the switching frequency, when the heat sink temperature is below a predetermined level, thereby expediting the equalization process.

Apparatus for controlling the charging level of a bank of serially connected n electrical cells (B₁ . . . Bₙ) performing equalization of the charges in the battery array, comprising:
a) circuitry for:
   a.1) alternately connecting a capacitor to pairs of adjacent battery cells by controlling switches at a predetermined switching frequency;
   a.2) alternately connecting an extra external capacitor to cells B₁ . . . Bₙ₋₁ and to cells B₂ . . . Bₙ;
b) circuitry for measuring the current of the extra capacitor;
c) a control circuitry for adjusting the switching frequency to control the impedance of the equivalent resistance of transfer (Rₑ), such that the charging/discharging current is maintained within a range of desired values.

### BRIEF DESCRIPTION OF THE DRAWINGS

The above and other characteristics and advantages of the present disclosure will be better understood through the following illustrative and non-limitative detailed description of preferred embodiments thereof, with reference to the appended drawings, wherein:

FIG. 1 (prior art) is an illustration of an array of n electrical cells B₁ . . . Bₙ connected in series, according to a conventional active method for performing equalization of the charge levels among these cells;

FIG. 2 (prior art) is an illustration of a partial section of a cell array in which cells B₁ and B₂ are connected in a series, with transistors S₁ . . . S₄ and capacitor C, according to a conventional active method for performing equalization of the charge levels among these cells, where (a) the original circuit; (b) when capacitor C is connected to cell B2; (c) when the capacitor C is connected to cell B1;

FIG. 3A (prior art) is an illustration of power transfer between two battery cells B₁ and B₂ by using a “flying capacitor”;

FIG. 3B (prior art) is an equivalent circuit of FIG. 3A;

FIG. 4 (prior art) shows three graphs of the current i(t) as a function of time, for three time constants RC, when a capacitor is connected to a battery;

FIG. 5 (prior art) shows a graph of the equivalent resistor Rₑ value as a function of the switching frequency f, in logarithmic scales [Hz];

FIG. 6 (prior art) shows a situation in which if the frequency will be lower than f_{c} (marked as f_{c}′) the resistance value of the equivalent resistor Rₑ is increased;

FIGS. 7A and 7B (prior art) show that two battery cells B1 and B2 can be described as a capacitor with a very large capacitance to emulate the behavior of the cells;

FIGS. 8A and 8B (prior art) show the equalization of two batteries, B1, B2 when emulated by equivalent capacitors Ce1 and Ce2;

FIG. 9 shows a schematic equivalent diagram of an adaptive equalizer circuit, according to an embodiment of the present disclosure;

FIG. 10A shows the equalization process over time according to the prior art, as obtained by circuit simulation;

FIG. 10B shows the equalization process over time according to one embodiment of this disclosure, as obtained by circuit simulation;

FIG. 11A is a schematic diagram of the equalization circuit for a plurality of serially connected battery cells, according to an embodiment of the present disclosure;

FIG. 11B is a schematic diagram of a controller with two gate drivers, which provide activation signals to the high side and to the low side switches, respectively, according to control signals from a controller;

FIG. 12A shows a possible implementation of providing the drive signals to all switches, without using isolated drivers;

FIG. 12B is a schematic diagram of the control pulses provided to transistors' gates, as a function of time;

FIG. 12C is a schematic diagram of the voltages between the gates and sources of transistors that form the switches of FIG. 12, as a function of time;

FIG. 13 shows a decision circuitry for determining when to start changing the switching frequency; and

FIG. 14 shows another decision circuitry for determining when to start changing the switching frequency, using an external common capacitor.

### DETAILED DESCRIPTION

The present disclosure proposes a system and method for comparing and performing equalization of the state of charge of an array of electrical cells connected in series to constitute a high voltage battery, in a manner that saves energy (power) and equalization time.

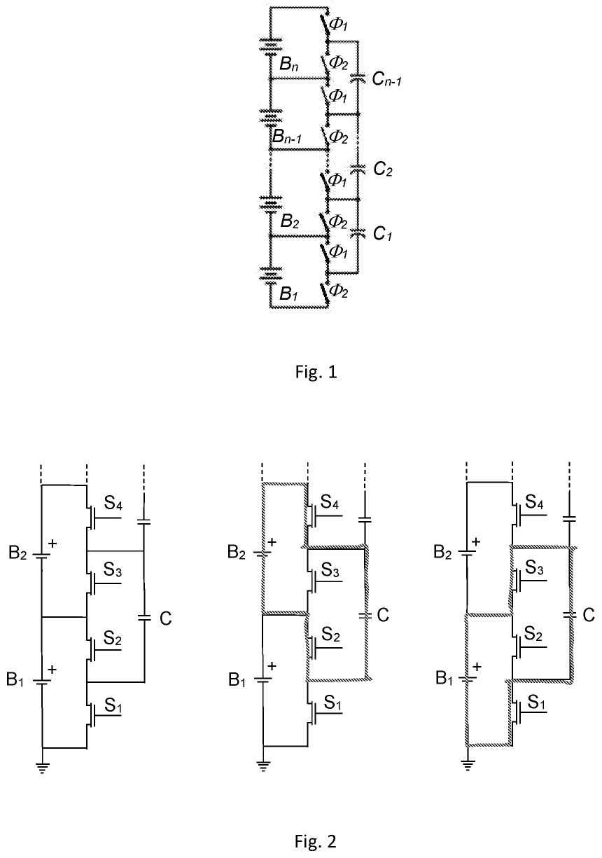

FIG. 1 (prior art) is an illustration of an array of n cells B₁ . . . Bₙ connected in series to constitute a high voltage battery, according to a conventional active method for performing equalization of the state of charge levels among these cells. The switches Φ₁ and Φ₂ work in tandem, thereby connecting sequentially each of the capacitors, C₁ . . . Cₙ₋₁ to an upper cell and then to a serially connected lower cell moving thereby charges from cells with high state of charge to cells of lower state of charge. This process continues until the state of charge of all cells is equal.

FIG. 2 (prior art) is an illustration of an equalization circuit comprising two batteries B₁ and B₂ connected in series, with switching transistors S₁ . . . S₄ and a capacitor C, according to a conventional active method for performing equalization of the charge levels between batteries B₁ and B₂. When S₂ and S₄ are conducting, capacitor C is connected to B₂. When S₁ and S₃ are conducting, capacitor C is connected to B₁ In such a conventional active method, the loss of energy is relatively small, compared to the passive methods, because most of the energy moves from one capacitor to another. However, this method has a slow reaction and it takes a lot of time until reaching equalization.

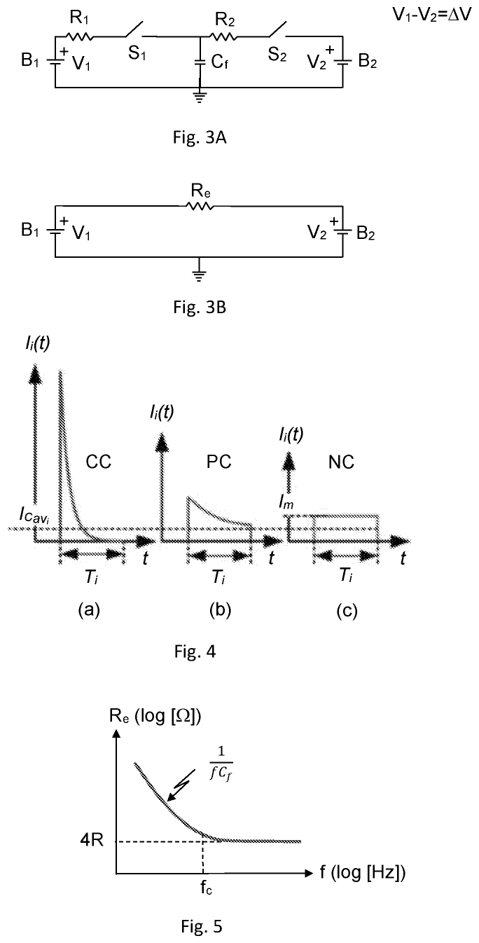

FIG. 3A (prior art) is an illustration of an equivalent circuit that represents a basic module of a conventional equalization circuit in which two cells B₁ and B₂ are connected in series. In this circuit, by controlling switches S₁ and S₂ capacitor C_{f} is alternately connected to batteries B₁ and B₂ as in the original array shown in FIG. 1. Resistors R₁ and R₂ represent losses of switches S₁ and S₂, respectively.

As known in the art (e.g. S. Ben-Yaakov, “On the Influence of Switch Resistances on Switched-Capacitor Converter Losses,” in IEEE Transactions on industrial Electronics, vol. 59, no. 1, pp. 638-640, January 2012, doi: 10.1109/TIE.2011.2146219), the equalization circuit of FIG. 3A can be replaced by one equivalent resistor Rₑ, shown in FIG. 3B, connecting the two cells B₁ and B₂. The energy in the circuit passes from B₁ to B₂ through the equivalent resistor Rₑ, while the energy loss is a function of the voltage difference ΔV (ΔV=V−V2) across the resistor Rₑ. Since this voltage is small compared to the cell voltages V_{B1}, V_{B2} the relative power loss of the transfer is small and is equal to ΔV/V_{B2}, and the momentary efficiency is equal to V_{B2}/V_{B1} (see M. Evzelman and S. Ben-Yaakov, “Average-Current-Based Conduction Losses Model of Switched Capacitor Converters,” in IEEE Transactions on Power Electronics, vol. 28, no. 7, pp. 3341-3352, July 2013, doi: 10.1109/TPEL.2012.2226060.)

FIG. 4 (prior art) shows three graphs of the flying capacitor current i(t), during the switching duration, as a function of time, in three situations for the active equalization circuit of FIG. 3A. Situation (a) represents a state (denoted by CC) where transistor S₁ is conducting for a relatively long time relative to the time constant of the circuit, (i.e., low switching frequency). In this case, the capacitor C is charged/discharged until it converges to a constant voltage equal to the voltage at the point to which the capacitor C is connected. Situation (c) represents a state (denoted by NC) where the time that transistor S₁ is conducting is very short relative to the time constant. In this case, the capacitor C is hardly enough to be charged at this short time, there is still current in the circuit, but this current is pretty constant because the capacitor does not change its voltage at this short time. In this case, the resistance of the transistors determines the magnitude of the current. Situation (c) happens when the switching frequency f is relatively high (fast switching frequency). Situation (b) represents an intermediate state (denoted by PC), where the time constant is not very short and not very long. In this situation, the capacitor C is charged and the current i(t) decreases with time until it converges to a constant value. The values of the equivalent resistor Rₑ in FIG. 3B depend on the shape of the RMS currents shown in FIG. 4, where situation (c) has the lowest RMS value and hence the lowest Rₑ value and situation (a) has the highest RMS value and the highest Rₑ value.

FIG. 5 (prior art, e.g. M. Evzelman and S. Ben-Yaakov, “Average-Current-Based Conduction Losses Model of Switched Capacitor Converters,” in IEEE Transactions on Power Electronics, vol. 28, no. 7, pp. 3341-3352, July 2013, doi: 10.1109/TPEL.2012.2226060) shows a graph of the equivalent resistor Rₑ value as a function of the switching frequency f, in a logarithmic scale [Hz]. At low switching frequencies, the equivalent resistor (Rₑ) value depends only on the capacitor C value and the switching frequency f, and does not depend on the resistance values of the transistors, represented by R₁ and R₂ (of FIG. 1). The value of Rₑ in this region is defined by Rₑ=1/fC_{f}. This means that the values of resistors R₁ and R₂ can be small or large and the result of Rₑ value will still be the same. Hence, in this region, the resistances of transistors S₁ and S₂ do not affect the Rₑ value and therefore, taking transistors with smaller resistance will not change Rₑ (since only the capacitor C and switching frequency f affect the resistor Rₑ value). From the graph of FIG. 5, one can see that the resistor Rₑ value decreases as the frequency increases to a certain point marked f_{c}, where the resistor Rₑ stabilizes to a constant value. f_{c} is defined by: f_{c}=1/(8RC). At this point, the capacitor value C no longer affects the resistor Rₑ value, and the resistance of the equivalent resistor Rₑ is determined solely by the total resistances of the switching transistor. The value of Rₑ in this range is defined by Rₑ=4R where R₁=R₂=R. This behavior is due to the fact that at region (C), the conduction durations of the transistors are short as compared to the time constant of the circuit, and hence, the magnitude of the charge-discharge currents is essentially constant, as depicted in FIG. 4(C) because it is controlled only by the resistance of the circuit. This, almost constant current, has a low RMS value and therefore the Re value in this frequency switching range is the lowest. Beyond the breaking point frequency fc, the equivalent resistance stays about constant and does not change when the frequency is increased.

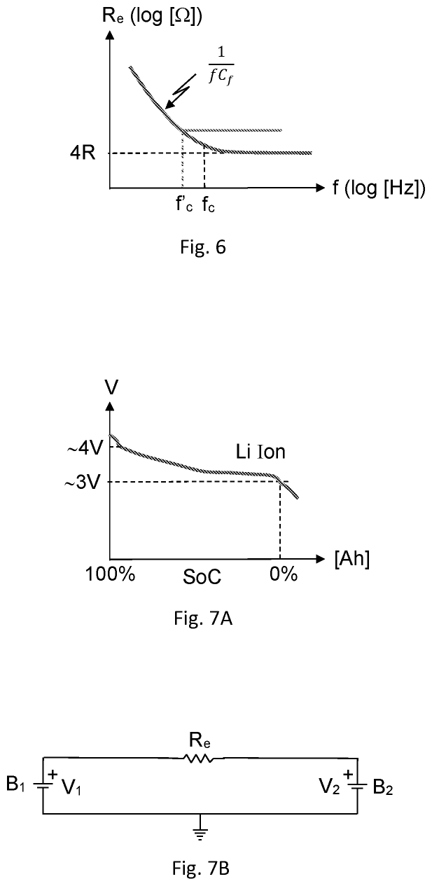

The behavior of Re as a function of frequency, as depicted in FIG. 5, is utilized in the present disclosure to control the rate at which the power is transferred from one battery cell to another. This is accomplished by changing (or adjusting) the switching frequency as depicted in FIG. 6. For example, the charge/discharge rate can be reduced by increasing the value of Re which is accomplished by moving from, say, switching frequency fc to to f′c when ΔV is large and moving back to fc when ΔV becomes smaller. This will keep the equalization power loss to within the safe region for transistors when ΔV is large, while increasing the rate of power transfer when ΔV is small.

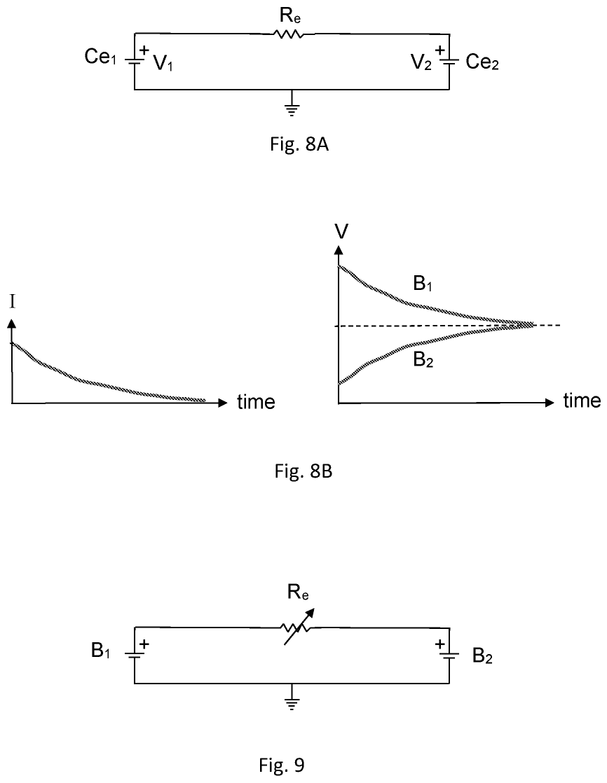

FIG. 7A (prior art) shows a typical charge-discharge curve of a Li-Ion battery, in which the cell voltage V is plotted as a function of the State Of Charge (SOC) which is the amount of charge Q stored in the battery divided by the maximum charge capacity Qₘₐₓ (SOC=Q/Qₘₐₓ). This behavior can be emulated by a large capacitor Cₑ (Cₑ=Qₘₐₓ/ΔV_{B}, where ΔV_{B} is the battery voltage change from 0% to 100% SOC). Hence, the interconnection of the two cells B₁ and B₂ (FIG. 7B) via the equivalent resistor Re, can be described as a connection of two capacitors of a very large value via the equivalent resistor Rₑ (FIG. 8A). The charge/discharge voltages of the cells shown in 7B thus behave like the charge/discharge of capacitors as depicted in FIG. 8A. Starting with a deviation between the voltages of the two cells (assuming that the voltage of B₁ is higher than of B₂), the current passing from B₁ to B₂ discharges B₁ and charges B₂ until the voltages of the cells are equal, as depicted in FIG. 8B.

Considering the situation of two cells B₁ and B₂ that are emulated as two equivalent (large) capacitors Cₑ₁ and Cₑ₂ in which, say, the equivalent capacitor Cₑ₁ is discharged and the equivalent capacitor Cₑ₂ is charged, the time constant of the system, in this case, is determined by the value of the equivalent resistor Rₑ and the series connection of two capacitors. The decrease of the average current I as a function of time is thus described by exponential decay and defined by: I=ΔV*e^{-t/(Re*CT)}/Rₑ, wherein C_{T}=(Cₑ₁*Cₑ₂)/(Cₑ₁+Cₑ₂), as shown schematically in FIG. 8B. The current change is a result of the fact that (in the case exemplifies by FIG. 7B) power is transferred from battery B₁ to B₂ and hence the voltage of B₁ drops while the voltage of B₂ increases until the two are equal. This type of behavior prevails in the prior art BMS systems.

The problem here is that at the beginning of the process the charging/discharging current is high while at the end it is very low. If the current I is very large and power dissipated by the transistors is high, and the heat generated in the system could be difficult to remove. This high heat dissipation causes the transistors S₁ and S₂ of FIG. 2 to overheat. If however, as in prior art, the initial current is decreased to reduce the power loss, the equalization time will become very long. This is because toward the end of the equalization process, the current tapers off to low values. Controlling the value of Rₑ, by changing the switching frequency, according to the present disclosure, makes it possible to shape the magnitude of the current as a function of time, along the equalization interval. In order to avoid losses and overheating of the switches, low switching frequency will be used at the beginning of equalization, such that the value of Rₑ, will be larger and therefore, the starting current will be lower. As time passes, the switching frequency will be increased to reduce Rₑ and flatten the current curve to be maintained high.

FIG. 9 shows a generic equivalent circuit of an adaptive equalizer circuit, according to an embodiment of the present disclosure. In this circuit, the value of resistor Rₑ is changed by changing the switching frequency, per the behavior depicted in FIG. 5, and by this, the circuit overcomes at least two problems. The first problem is high power dissipation when the value of resistor Rₑ is small and the second problem: long equalization time when value of resistor Rₑ is large.

As illustrated in FIG. 5, the changes of the value of resistor Rₑ are frequency dependent. Utilizing this feature, the adaptive equalizer circuit according to an embodiment of the present disclosure, changes the switching frequency as the equalization process advances. At the beginning of the equalization process, an initial operating point is selected in the region of higher Rₑ, depending on the level of the desired power dissipation (which is converted to heat). Equalization begins when the voltage difference between any two cells is larger than a predefined value and ends when the voltage difference is smaller than a predefined value. The control of the value can be accomplished in a number of ways. One embodiment according to the present disclosure is to change the switching frequency as a function of time in a predefined profile and by this decrease the value of Rₑ in “open-loop”, to help keep the current magnitude at a constant level.

According to another embodiment of this disclosure, the operation is in “closed-loop”. In this case, the magnitude of the charge/discharge current is monitored, either directly or indirectly, and the switching frequency is changed accordingly, so as to keep the current level substantially constant. Upon detecting that the magnitude of the charge/discharge current dropped to a predefined value, the equalization process is stopped to eliminate power drain by the BMS, while the batteries are already equalized. In another possible embodiment of this disclosure, the change in switching frequency is made a function of the voltage difference between the batteries (in the exemplified case V₁−V₂), As the voltage difference drops, the switching frequency is increased and as a result, the value of Rₑ decreases and the current increases (even though Vₐ−V_{b} has dropped).

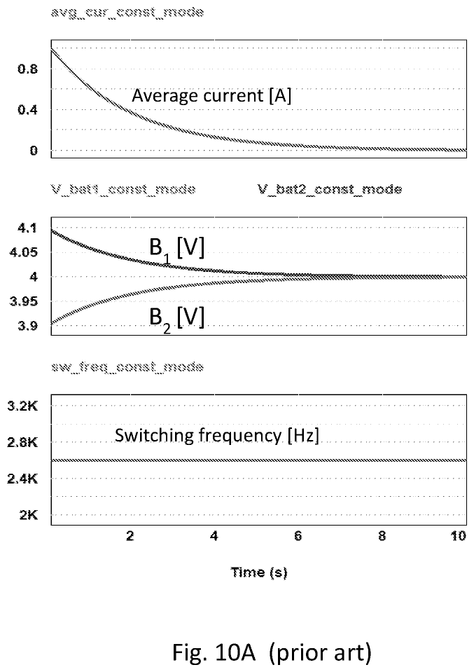

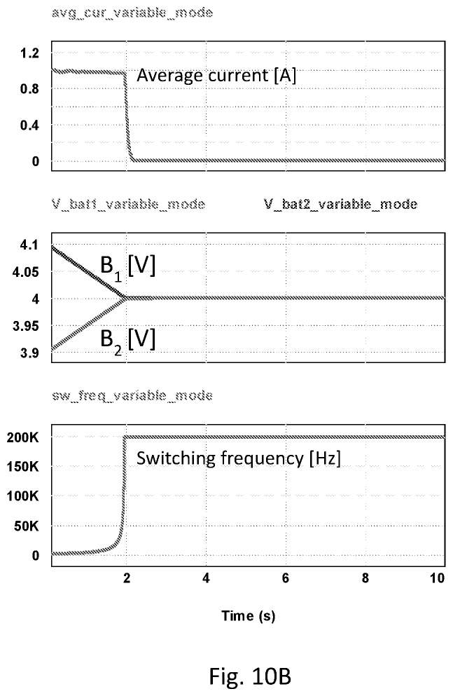

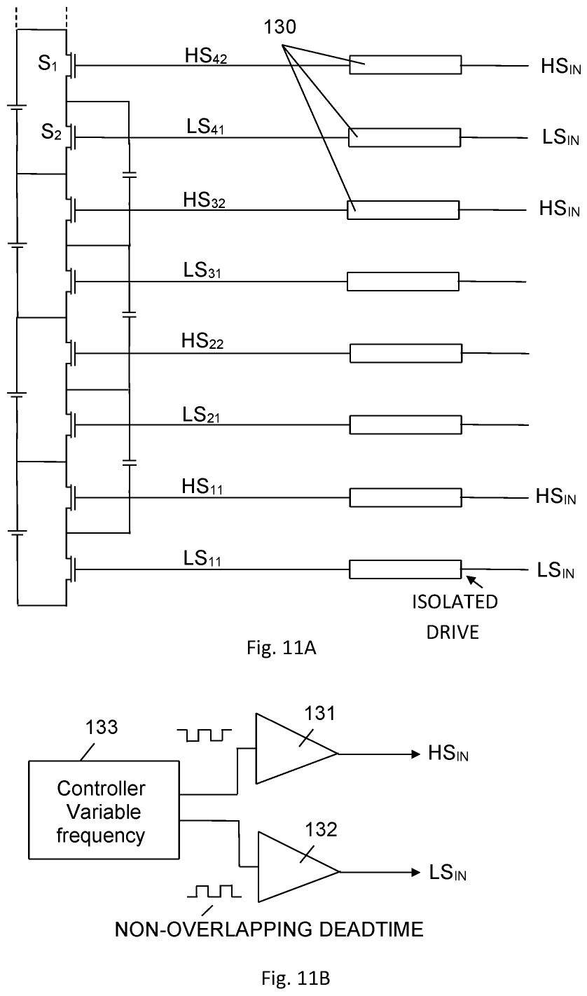

FIG. 10A shows the equalization process over time as obtained by simulation according to prior art, that is, with a constant switching frequency, the current limit was set to 1A. It can be seen that the initial voltages of cells B₁ and B₁ are 200 mV apart and converge to a common value, which is the end of the equalization process. The initial value of current (1A) drops exponentially and it takes about 6 seconds in this example to reach equilibrium. FIG. 10B is a non-limiting example of the equalization process according to one embodiment of this disclosure. Here, the current is not only limited to 1A but is kept constant at this level by changing the switching frequency along the equalization process. In this example, the equalization time is about 2 seconds, 3 times faster than the case of prior art embodiment as depicted in FIG. 10A.

As will be clear to a person skilled in the art, the above explanation that focused, for the sake of clarity, on the case of two cells in a battery array, is valid for the case of a string of n cells that form a higher voltage battery array.

FIG. 11A is a schematic diagram of the equalization circuit for a plurality of serially connected batteries B₁ . . . Bₙ, according to an embodiment of the present disclosure. The circuit (a “charge pump” drive) is based on alternately connecting capacitors C to two neighbouring cells (i.e., to pairs of adjacent battery cells), using a series of switching transistors S₁ . . . Sₙ driven by isolated gate drivers 130 for activating the high side and low side transistors to connect/disconnect capacitors C₁ . . . Cₙ to batteries B₁ . . . Bₙ, respectively, according to a desired switching frequency according to this disclosure. All transistors that connect the capacitors to the high side are activated simultaneously, and all transistors that connect the capacitors to the low side are activated simultaneously, as well.

FIG. 11B is a schematic diagram of a high side driver 131 and a low side driver 132, which provides activation signals HSᵢₙ and LSᵢₙ, via the isolated gate drivers, to the high side and to the low side transistors, respectively, according to control signals (with no overlapping deadtimes) from a controller 133. The controller 133 provides the high side and low side pulse at frequencies that maintains the charging/discharging currents at the design level within a range of desired values. The switching frequency is adjusted to control the impedance of the equivalent resistance of transfer (Rₑ), such that the charging/discharging current is maintained within a range of desired values.

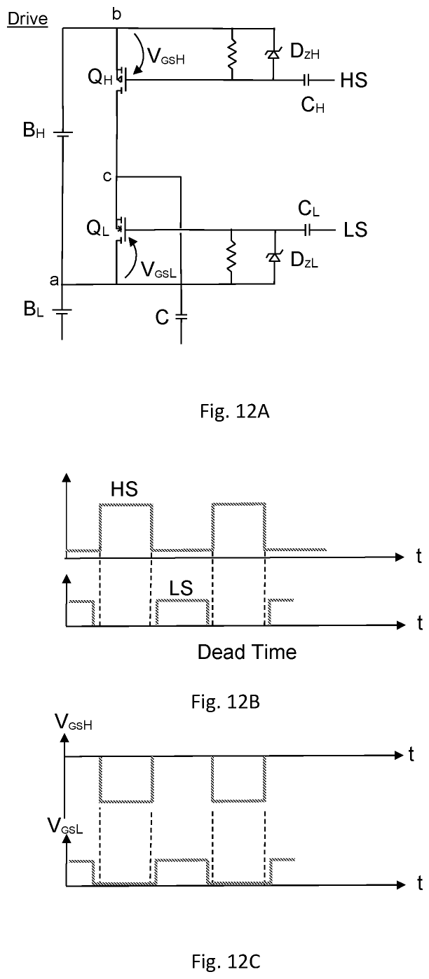

FIG. 12A shows another possible embodiment of the present disclosure, in which the drive signals to all switches are provided, without using isolated drivers (as shown in FIG. 11A above). Instead, the switching signals are fed to each switch via a series of DC decoupling capacitors C_{H} and C_{L}. When a pulse is fed into C_{L}, the positive pulse portion passes to the gate of Q_{L} and capacitor C_{L} discharges via Q_{L} (an n-channel FET), which is conducting, to pass energy from capacitor C to battery cell BL. When the pulse becomes negative, the negative pulse portion causes Q_{L} to stop conducting and capacitor C_{L} is charged back to the former voltage via DZ_{L}, to be ready for the next cycle. The source of Q_{L} is always connected to a stable voltage (point a, which is a port of a battery cell), such that the voltage Vgs_{L} is accurate. In this arrangement, capacitors C_{L} and C_{H} block the DC voltage between the gates of the transistors and the system's ground (to which drivers 131 and 132 are referred), which may be hundreds of volts with respect to ground.

Similarly, when a pulse is fed into C_{H}, the negative pulse portion passes to the gate of Q_{H} (a p-channel FET) and capacitor C_{H} discharges via Q_{H}, which is conducting, to pass energy from capacitor C to battery cell B_{H}. When the pulse becomes positive, the positive pulse portion causes Q_{H} to stop conducting and capacitor C_{H} is charged back to the former voltage via DZ_{H}, to be ready for the next cycle. The source of Q_{H} is always connected to an accurate voltage (point b, which is a port of a battery cell), such that the voltage Vgs_{H} is accurate.

FIG. 12B is a schematic diagram of the control pulses HS and LS, provided to capacitors C_{H} and C_{L} (of FIG. 12A), respectively, as a function of time. It can be seen that there are deadtimes so as to prevent Q_{L} and Q_{H} from conducting at the same time. FIG. 12C is a schematic diagram of the voltages Vgs_{H} and Vgs_{L} provided to switches Q_{H} and Q_{L} (of FIG. 12A), respectively, as a function of time.

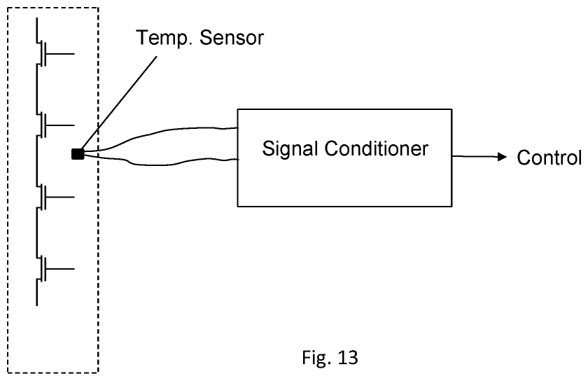

FIG. 13 shows an embodiment of a control circuitry for changing the switching frequency along the equalization process, according to an embodiment of the present disclosure. In this example, all the switching transistors S₁ . . . Sₙ are connected to a common heatsink or a number of common heatsinks. One way is to measure the temperature of the heatsink (such that the temperature of the heatsink will not increase above a predetermined value) and if the heatsink temperature increases, the controller 133 will decrease the switching frequency and as a result, the value of resistor Rₑ increases and the current decreases. As the battery starts to be equalized, the switching frequency will be thus increased automatically. This will reduce the value of resistor Rₑ and the heat dissipation will be almost the same, in order not to exceed the maximum desired rating.

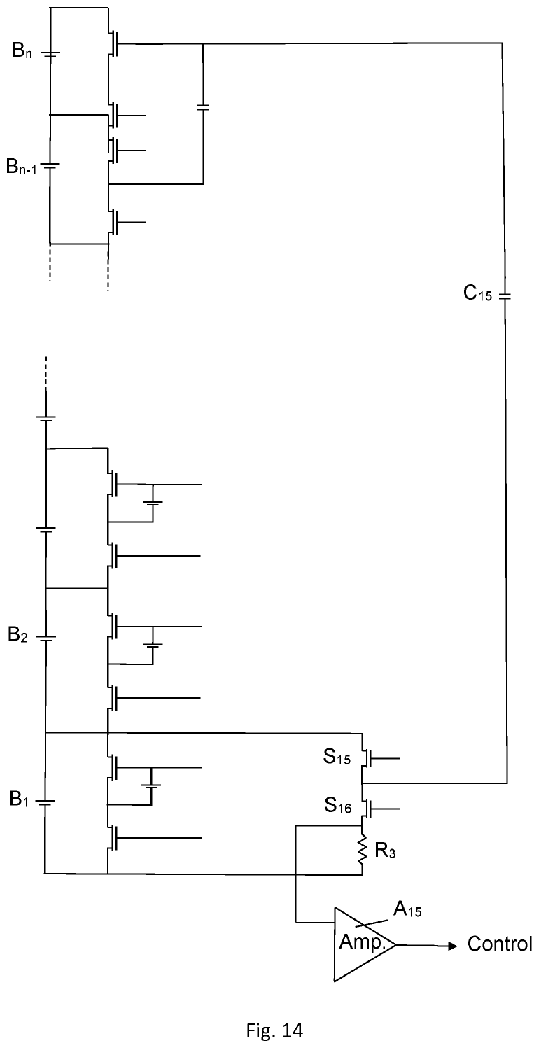

FIG. 14 shows another embodiment of a decision circuitry, according to this disclosure, for either controlling the switching frequency continuously or stepwise, by using an external common capacitor C₁₅ and an extra pair of transistors S₁₅, S₁₆. The transistors are connected between the B₁, B₂ junction and a sense resistor Rs which is connected at the other end to ground. The sense resistor is connected between ground and a transistor that toggles the external capacitor. The controller's decision to start or stop the equalization process is based on the current magnitude of the external capacitor.

In this example, there are n battery cells and the drivers are adapted to activate the lower and upper transistors per FIGS. 13A and 14. This way, only two drivers are still sufficient to activate the equalization circuit (shown in FIG. 13A), while eliminating the need to use expensive isolated drivers.

According to this embodiment of present disclosure, the extra capacitor C₁₅ is connected between the midpoint of transistors S₁, S₂ and the midpoint of transistors S₁₅, S₁₆. By this, C₁₅ will be switched across the cells B₀ to Bₙ₋₁ and then across the cells B₂ to Bₙ. When the battery array is equalized, the voltages across these two strings will be equal and the charge/discharge current of C₁₅ will be zero. If the array is still unbalanced, the current of capacitor C₁₅ will be nonzero and will show up as voltage spikes across R_{S}. These spikes are amplified by amplifier A₁₅ and fed to the controller that changes the switching frequency to keep the charge/discharge current at a predefined level. Once the magnitude of the current reaches a sufficiently low level (per design requirements) the controller will stop the equalization process to save power.

The above examples and description have of course been provided only for the purpose of illustrations, and are not intended to limit the disclosure in any way. As will be appreciated by the skilled person, the disclosure can be carried out in a great variety of ways, employing more than one technique from those described above, all without exceeding the scope of the disclosure.

1. A method for controlling charging levels of a bank of serially connected electrical battery cells and performing equalization of charges in the battery cells, comprising:
a) alternately connecting an equalizing capacitor to pairs of adjacent battery cells by controlling switches at a predetermined switching frequency; and
b) adjusting said switching frequency to control an impedance of an equivalent resistance of transfer (Rₑ), such that charging/discharging current is maintained within a range of desired values.

2. A method according to claim 1, wherein equalization begins when a voltage difference between any two battery cells is larger than a predefined value and ends when the voltage difference is smaller than a predefined value.

3. A method according to claim 1, wherein the switching frequency changes according to a predefined profile of the switching frequency, versus time.

4. A method according to claim 1, further comprising:
determining when to start changing the switching frequency by measuring a temperature of a heatsink/heatsinks, which dissipates power losses during equalization of all battery cells, such that the temperature of the heatsink/heatsinks will not increase above a predetermined value; and
reducing the equivalent resistance of transfer by increasing the switching frequency, when the temperature of the heatsink/heatsinks is below a predetermined level, thereby expediting the equalization process.

5. A method according to claim 1, wherein drive signals are provided to all of the switches, without using isolated drivers by providing switching signals to each switch via series DC decoupling capacitors, such that when a pulse is fed into a respective series DC decoupling capacitor, a positive portion of the pulse passes to the gate of a respective switch to pass energy from the equalizing capacitor to one of the battery cells while allowing the respective series DC decoupling capacitor to charge back to a former voltage during a negative portion of the pulse, to be ready for a next cycle.

6. A method for controlling charging levels of a bank of serially connected n electrical battery cells (B₁ . . . Bₙ) and performing equalization of the charges in the battery cells, comprising:
a) alternately connecting an equalizing capacitor to pairs of adjacent battery cells by controlling switches at a predetermined switching frequency;
b) alternately connecting an external capacitor to battery cells B₁ . . . Bₙ₋₁ and to battery cells B₂ . . . Bₙ;
c) measuring a current of said external capacitor; and
d) adjusting said switching frequency to control an impedance of an equivalent resistance of transfer (Rₑ), such that charging/discharging current is maintained within a range of desired values.

7. A method according to claim 6, wherein the current of the external capacitor is passed through a sense resistor, a voltage drop across which is fed into a controller, being capable of changing the switching frequency.

8. A method according to claim 7, wherein the sense resistor is connected between ground and a transistor that toggles the external capacitor.

9. A method according to claim 7, wherein the controller decides to start or stop the equalization process based on a magnitude of the current of the external capacitor.

10. Apparatus for controlling charging levels of a bank of serially connected electrical battery cells and performing equalization of charges in the battery cells, comprising:
a) circuitry configured for alternately connecting an equalization capacitor to pairs of adjacent battery cells by controlling switches at a predetermined switching frequency; and
b) circuitry configured for adjusting said switching frequency to control an impedance of an equivalent resistance of transfer (Rₑ), such that charging/discharging current is maintained within a range of desired values.

11. Apparatus according to claim 10, in which equalization begins when a voltage difference between any two battery cells is larger than a predefined value and ends when the voltage difference is smaller than a predefined value.

12. Apparatus according to claim 10, in which the switching frequency changes according to a predefined profile of the switching frequency, versus time.

13. Apparatus according to claim 10, in which the control circuitry is adapted to:
determine when to start changing the switching frequency by measuring a temperature of a heatsink/heatsinks, which dissipates power losses during equalization of all battery cells, such that the temperature of the heatsink/heatsinks will not increase above a predetermined value; and
reduce the equivalent resistance of transfer by increasing the switching frequency, when the temperature of the heatsink/heatsinks is below a predetermined level, thereby expediting the equalization process.

14. Apparatus according to claim 10, in which drive signals are provided to all of the switches, without using isolated drivers by providing switching signals to each switch via series DC decoupling capacitors, such that when a pulse is fed into a respective series DC decoupling capacitor, a positive portion of the pulse passes to the gate of a respective switch to pass energy from the equalizing capacitor to one of the battery cells while allowing the respective series DC decoupling capacitor to charge back to a former voltage during a negative portion of the pulse, to be ready for a next cycle.

15. Apparatus for controlling charging levels of a bank of serially connected n electrical battery cells (B₁ . . . Bₙ) and performing equalization of charges in the battery cells, comprising:
a) circuitry configured for:
a.1) alternately connecting an equalizing capacitor to pairs of adjacent battery cells by controlling switches at a predetermined switching frequency;
a.2) alternately connecting an external capacitor to battery cells B₁ . . . Bₙ₋₁ and to battery cells B₂ . . . Bₙ;
b) circuitry configured for measuring a current of said external capacitor; and
c) control circuitry configured for adjusting said switching frequency to control an impedance of an equivalent resistance of transfer (Rₑ), such that the charging/discharging current is maintained within a range of desired values.

16. Apparatus according to claim 15, in which the current of the external capacitor is passed through a sense resistor, a voltage drop across which is fed into a controller, being capable of changing the switching frequency.

17. Apparatus according to claim 16, in which the sense resistor is connected between ground and a transistor that toggles the external capacitor.

18. Apparatus according to claim 16, in which the controller decides to start or stop the equalization process based on a magnitude of the current of the external capacitor.
